(19) United States
(12) Patent Application Publication
(10) Pub. No.: US 2008/0270011 A1
(43) Pub. Date: Oct. 30, 2008

(54) Apparatus for failure diagnosis of an intake air flow sensor

(76) Inventors: Hideyuki Takahashi, Kawasaki-shi (JP); Tadao Kobayashi, Kawasaki-shi (JP); Koji Oguchi, Kawasaki-shi (JP); Yoshiaki Moroguchi, Kawasaki-shi (JP)

Correspondence Address: JACOBSON HOLMAN PLLC, 400 SEVENTH STREET N.W., SUITE 600, WASHINGTON, DC, 20004, US

(21) Appl. No.: 12/149,006

(22) Filed: Apr. 24, 2008

(30) Foreign Application Priority Data
Apr. 27, 2007 (JP) 2007-118720

(51) Int. Cl. G01M 15/05

(52) U.S. Cl. 701/114

(57) ABSTRACT

An apparatus for failure diagnosis of an intake air flow sensor is provided which, when the operating state of an engine is judged to be in a low flow rate region, determines whether or not the intake air flow rate detected by the intake air flow sensor is excessively high relative to a theoretical intake air flow rate corresponding to the operating state of the engine and, if the detected intake air flow rate is excessively high, judges that the intake air flow sensor has failed. Also, when the operating state of the engine is judged to be in a high flow rate region, the apparatus for failure diagnosis determines whether or not the detected intake air flow rate is excessively low relative to the theoretical intake air flow rate and, if the detected intake air flow rate is excessively low, judges that the intake air flow sensor has failed.

### BACKGROUND OF THE INVENTION

1. Field of the Invention

The present invention relates to an apparatus for failure diagnosis device for diagnosing failure of an intake air flow sensor for detecting the flow rate of intake air supplied to an engine.

2. Description of the Related Art

The flow rate of intake air supplied to an engine is detected by an intake air flow sensor, and the detected flow rate is used for various control purposes. In gasoline engines, for example, based on the detected intake air flow rate and the revolving speed of the engine, a fuel injection quantity is determined using a map, and the determined fuel injection quantity is used for fuel injection control.

In diesel engines, a fresh air quantity is calculated from the intake air flow rate, detected by the intake air flow sensor, and an estimated quantity of oxygen remaining in EGR gas. Then, based on the fresh air quantity and the fuel injection quantity, an actual excess air ratio is calculated, and also based on the engine revolving speed and the fuel injection quantity, a target excess air ratio is calculated using a predetermined map. Using the actual and target excess air ratios, feedback control of EGR quantity, or what is called k control, is performed so that the actual excess air ratio may become equal to the target excess air ratio.

Accordingly, the intake air flow rate detected by the intake air flow sensor has a great influence on the fuel injection control or the EGR control. If the detected air flow rate contains a significant error because of failure of the intake air flow sensor, the engine is operated based on an improperly set fuel injection quantity or EGR quantity, increasing the emission of harmful components into the air. Thus, legal controls, for example, OBD (On Board Diagnosis)-related regulations adopted in North America require that automotive vehicles should be equipped with an apparatus for diagnosing failure of the intake air flow sensors. To comply with such regulations, various apparatuses for failure diagnosis have been proposed, as disclosed in Unexamined Japanese Patent Publication No. 2006-329138 (hereinafter referred to as Patent Document 1), for example.

In the apparatus for failure diagnosis disclosed in Patent Document 1, a theoretical intake air flow rate is calculated from the engine revolving speed and a turbocharger revolving speed. If an absolute value of the difference between the theoretical intake air flow rate and the detected intake air flow rate detected by the intake air flow sensor is greater than a predetermined value, the apparatus for failure diagnosis judges that the intake air flow sensor has failed.

With the apparatus for failure diagnosis of Patent Document 1, the intake air flow sensor is judged to have failed in the following situations: the situation where the detected intake air flow rate is higher than the theoretical intake air flow rate by more than a predetermined value (failure judgment made in this situation will be hereinafter referred to as high-output failure judgment); and the situation where the detected intake air flow rate is lower than the theoretical intake air flow rate by more than a predetermined value (failure judgment made in this situation will be hereinafter referred to as low-output failure judgment). In the apparatus for failure diagnosis of Patent Document 1, the high-output failure judgment and the low-output failure judgment are made at all times irrespective of the operating region of the engine, that is, over an entire engine operating region.

However, the engine operation varies widely depending on the engine revolving speed and the turbocharger revolving speed, and such a wide operating region includes regions not suited for the high-output failure judgment or the low-output failure judgment. In a low-load region, for example, the intake air flow rate is originally low, and therefore, even if the detected intake air flow rate decreases to a certain extent because of sensor error, it is difficult to precisely detect such decrease by the low-output failure judgment. Conversely, in a high-load region, the intake air flow rate is originally high, and thus, even if the detected intake air flow rate increases in some degree due to sensor error, it is difficult to precisely detect such increase by the high-output failure judgment. In such cases, therefore, the apparatus for failure diagnosis is unable to detect sensor failure, even though the intake air flow sensor has actually failed. Thus, inconveniences such as deterioration in emission characteristics may possibly be caused as a result of the fuel injection control or EGR control performed based on an inaccurately detected intake air flow rate.

### SUMMARY OF THE INVENTION

An aspect of the present invention is directed to an apparatus for failure diagnosis of an intake air flow sensor, comprising; intake air flow rate region discrimination means for determining whether or not an operating state of an engine falls within either one of a preset low flow rate region where an intake air flow rate of the engine is low, and a preset high flow rate region where the intake air flow rate is high; theoretical intake air flow rate calculation means for calculating, based on the operating state of the engine, a theoretical intake air flow rate corresponding to an actual intake air flow rate; an intake air flow sensor for detecting the intake air flow rate of the engine; high-output failure judgment means for determining, when it is judged by the intake air flow rate region discrimination means that the operating state of the engine is in the low flow rate region, whether or not the intake air flow rate detected by the intake air flow sensor is excessively high relative to the theoretical intake air flow rate calculated by the theoretical intake air flow rate calculation means, and judging, if the detected intake air flow rate is found to be excessively high, that the intake air flow sensor has failed; and low-output failure judgment means for determining, when it is judged by the intake air flow rate region discrimination means that the operating state of the engine is in the high flow rate region, whether or not the intake air flow rate detected by the intake air flow sensor is excessively low relative to the theoretical intake air flow rate calculated by the theoretical intake air flow rate calculation means, and judging, if the detected intake air flow rate is found to be excessively low, that the intake air flow sensor has failed.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 illustrates an entire construction of a diesel engine to which is applied an apparatus for failure diagnosis of an intake air flow sensor according to one embodiment of the present invention;

FIG. 2 is a flowchart showing a failure diagnosis routine executed by an ECU in the diesel engine of FIG. 1; and

FIG. 3 is a map showing low and high flow rate regions.

### DETAILED DESCRIPTION OF THE INVENTION

A preferred embodiment of the present invention will be hereinafter described in detail with reference to the accompanying drawings.

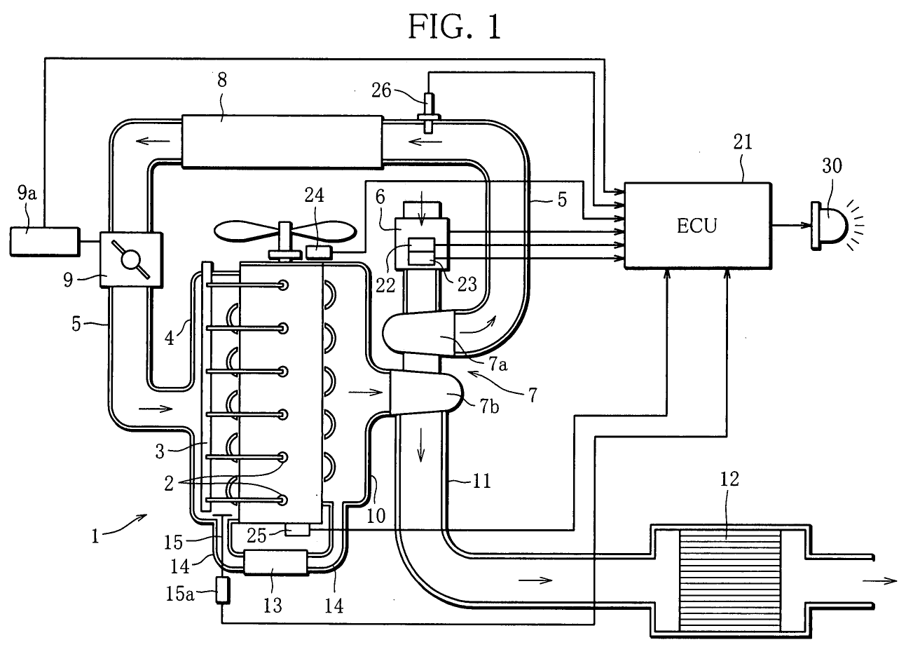

FIG. 1 illustrates an entire construction of a diesel engine (hereinafter referred to merely as engine) to which an apparatus for failure diagnosis of an intake air flow sensor according to the embodiment is applied. The engine 1 is an in-line six-cylinder engine, and each cylinder of the engine 1 is provided with a fuel injection valve 2. Each fuel injection valve 2 is supplied with pressurized fuel from a common rail 3 and, when opened, injects the fuel into the corresponding cylinder.

An intake manifold 4 for supplying intake air to the individual cylinders is mounted to the intake side of the engine 1. An intake passage 5 is connected to the intake manifold 4 and is provided with an intake air flow sensor 6 for measuring intake air flow rate Qa, a compressor 7a of a turbocharger 7, an intercooler 8, and an intake throttle valve 9 opened and closed by an actuator 9a in this order in the direction of the intake air flow.

An exhaust manifold 10, to which exhaust gas is discharged from the individual cylinders, is mounted to the exhaust side of the engine 1. The outlet of the exhaust manifold 10 is provided with a turbine 7b of the turbocharger 7 mechanically coupled to the compressor 7a coaxially therewith. An exhaust passage 11 is connected to the turbine 7b and provided with a catalytic converter 12 and a muffler, which is not shown.

The exhaust manifold 10 and intake manifold 4 are connected to each other by an EGR passage 14 with an EGR cooler 13. An EGR valve 15, which is opened and closed by an actuator 15a, is arranged in the EGR passage 14. The quantity of exhaust gas recirculated from the exhaust manifold 10 to the intake manifold 4, that is, the EGR quantity of the engine 1, is adjusted by varying the opening of the EGR valve 15.

An ECU (electronic control unit) 21 is arranged in the passenger compartment of the vehicle and comprises input/output devices, memory units (ROM, RAM, etc.) storing control programs, control maps and the like, a central processing unit (CPU), timer counters, etc., none of which are shown.

To the input of the ECU 21, various sensors such as the intake air flow sensor 6, an atmospheric pressure sensor 22, an intake air temperature sensor 23, a revolving speed sensor 24, a water temperature sensor 25, and a boost pressure sensor 26 are connected. The atmospheric pressure sensor 22 and the intake air temperature sensor 23 are both built in the intake air flow sensor 6 and detect atmospheric pressure Pa and intake air temperature Ta, respectively. The revolving speed sensor 24 detects revolving speed Ne of the engine 1, and the water temperature sensor 25 detects cooling water temperature Tw of the engine 1. The boost pressure sensor 26 detects boost pressure Pb raised by the turbocharger 7. To the output of the ECU 21, on the other hand, various devices such as the fuel injection valves 2, the actuator 9a of the intake throttle valve 9, the actuator 15a of the EGR valve 15, and a warning light 30 located near the driver's seat of the vehicle are connected.

The ECU 21 sets target values for the fuel injection quantity, injection timing, common rail pressure and the like on the basis of information on detected values such as the driver's accelerator depression amount and the engine revolving speed Ne. Then, in accordance with the target values, the ECU 21 executes various control actions such as drive-control of the fuel injection valves 2 and adjustment of the common rail pressure, to operate the engine 1.

The ECU 21 carries out so-called k control as a control of the EGR quantity. The k control is a control technique commonly known in the art and, therefore, will not be explained in detail here. Outline of the k control performed in this embodiment is as follows: The ECU 21 calculates a fresh air quantity from the intake air flow rate Qa, detected by the intake air flow sensor 6, and an estimated quantity of oxygen remaining in the EGR gas. Then, the ECU 21 calculates an actual excess air ratio from the fresh air quantity and the fuel injection quantity, and also calculates, based on the engine revolving speed Ne and the fuel injection quantity, a target excess air ratio by using a predetermined map. The ECU 21 controls the opening of the EGR valve 15 so that the actual excess air ratio may become equal to the target excess air ratio.

The λ control is executed in this manner, and accordingly, if the intake air flow rate Qa contains a relatively large error because of failure of the intake air flow sensor 6, the engine 1 is operated on the basis of an inappropriately set excess air ratio. As a result, the amount of harmful components emitted to the atmosphere increases. To avoid such an inconvenience, according to this embodiment, the ECU 21 diagnoses failure of the intake air flow sensor 6. In the following, the failure diagnosis of the intake air flow sensor 6 will be explained in detail.

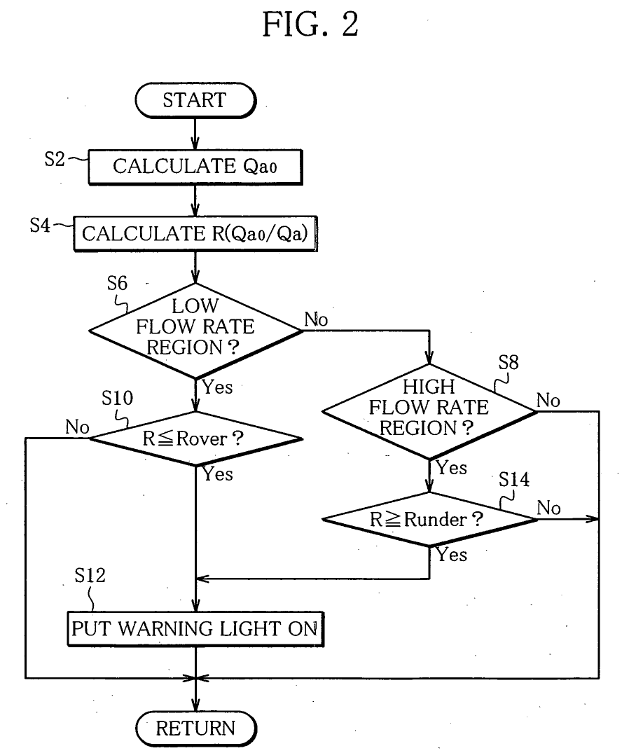

FIG. 2 is a flowchart illustrating a failure diagnosis routine executed by the ECU 21. The ECU 21 executes the routine at predetermined control intervals while the ignition switch of the vehicle is ON.

First, in Step S2, the ECU 21 calculates a theoretical intake air flow rate Qao (theoretical intake air flow rate calculation means). The theoretical intake air flow rate Qao is an intake air flow rate estimated from the operating state of the engine 1 and assumes a value corresponding to an actual intake air flow rate. Namely, the theoretical intake air flow rate Qao can be regarded as a detected intake air flow rate Qa detected by the normally operating intake air flow sensor 6 and containing no error. In this embodiment, the ECU 21 calculates the theoretical intake air flow rate Qao by obtaining a base intake air flow rate from the engine revolving speed Ne and then correcting the base intake air flow rate with the use of correction values. The correction values used at this time are set respectively based on the atmospheric pressure Pa detected by the atmospheric pressure sensor 22, the intake air temperature Ta detected by the intake air temperature sensor 23, the cooling water temperature Tw detected by the water temperature sensor 25, the boost pressure Pb detected by the boost pressure sensor 26, and the injection quantity determined for the fuel injection control.

The method of calculating the theoretical intake air flow rate Qao is, however, not limited to the above one. For example, the theoretical intake air flow rate Qao may be calculated from the engine revolving speed Ne and the turbocharger revolving speed (the revolving speed of the turbine 7a), as in Patent Document 1.

Subsequently, in Step S4, the ECU 21 acquires the intake air flow rate Qa detected by the intake air flow sensor 6 (hereinafter referred to as detected intake air flow rate Qa), and then calculates the ratio R (=Qao/Qa) of the theoretical intake air flow rate Qao to the detected intake air flow rate Qa. Where the detected intake air flow rate Qa is accurate and equal to the theoretical intake air flow rate Qao, the ratio R assumes the value “1.0”. As the detected intake air flow rate Qa deviates in the increasing direction from the theoretical intake air flow rate Qao due to the occurrence of error, the value of the ratio R decreases. Conversely, as the detected intake air flow rate Qa deviates in the decreasing direction from the theoretical intake air flow rate Qao, the value of the ratio R increases.

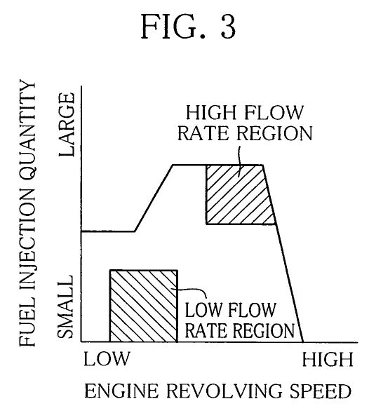

The ECU 21 then determines in Step S6 whether or not the operating state of the engine 1 falls within a preset low flow rate region (intake air flow rate region discrimination means). Plainly speaking, the low flow rate region is an operating region where the intake air flow rate Qa of the engine 1 is low because the engine 1 is operated at low revolving speed and low boost pressure with low load. The range of the low flow rate region is exemplified in the map of FIG. 3 showing the fuel injection quantity in relation to the engine revolving speed. Specifically, when the engine revolving speed Ne, the cooling water temperature Tw, the fuel injection quantity, the atmospheric pressure Pa, the boost pressure Pb and the opening of the intake throttle valve 9 fall within respective predetermined ranges, the ECU 21 judges that the operating state of the engine 1 is in the low flow rate region.

If the operating state of the engine 1 is not in the low flow rate region and the decision in Step S6 is “No”, the ECU 21 advances the procedure to Step S8 and determines whether or not the operating state of the engine 1 falls within a preset high flow rate region (intake air flow rate region discrimination means). If the operating state of the engine 1 is not in the high flow rate region and the decision in Step S8 is “No”, the ECU 21 ends the current execution of the routine. The high flow rate region is an operating region where the intake air flow rate Qa of the engine 1 is high because the engine 1 is operated at high revolving speed and high boost pressure with high load. Specifically, the ECU 21 determines whether the operating state of the engine 1 falls within the high flow rate region or not, based on the above requirements used for the discrimination of the low flow rate region, namely, based on the engine revolving speed Ne, the cooling water temperature Tw, the fuel injection quantity, the atmospheric pressure Pa, the boost pressure Pb and the opening of the intake throttle valve 9 (Needless to say, respective different ranges are set for the individual requirements in discriminating the above two regions). However, when discriminating the high flow rate region, the ECU 21 uses the opening of the EGR valve 15 as an additional requirement. The reason will be explained later.

The low flow rate region is set as a region in which increase in the detected intake air flow rate Qa due to excessively high output of the intake air flow sensor 6 appears noticeably. On the other hand, the high flow rate region is set as a region in which decrease in the detected intake air flow rate Qa due to excessively low output of the intake air flow sensor 6 appears noticeably. In these regions, the ECU 21 makes high- and low-output failure judgments, respectively, on the output of the intake air flow sensor 6, as described below. In this embodiment, in order that increase and decrease of the detected intake air flow rate Qa may appear more noticeably, the low flow rate region is set in the vicinity of the lower limit including a minimum intake air flow rate, within an entire intake air flow rate region of the engine 1, while the high flow rate region is set in the vicinity of the upper limit including a maximum intake air flow rate. Also, a region in which neither high-output failure judgment nor low-output failure judgment is made (i.e., the situation where the decision in Step S8 is “No”) is defined between the low and high flow rate regions.

The manner of setting the low and high flow rate regions is, however, not particularly limited, and the regions may be set in a different way. For example, the entire intake air flow rate region may be divided into two, and one region lower in intake air flow rate may be set as the low flow rate region while the other region higher in intake air flow rate may be set as the high flow rate region.

If the operating state of the engine 1 is judged to be in the low flow rate region and thus the decision in Step S6 is “Yes”, the ECU 21 advances the procedure to Step S10 and makes the high-output failure judgment on the output of the intake air flow sensor 6, namely, it is determined whether or not the ratio R assumes a value smaller than or equal to a high-output failure criterion value Rover (high-output failure judgment means). The high-output failure criterion value Rover corresponds to an allowable limit on incremental error of the detected intake air flow rate Qa relative to the theoretical intake air flow rate Qao. Naturally, therefore, the high-output failure criterion value Rover is set to a value (e.g., “0.4”) smaller than “1.0” (i.e., Qao=Qa). If the decision in Step S10 is “No”, the ECU 21 judges that the output of the intake air flow sensor 6 is not excessively high, followed by the termination of the routine. On the other hand, if the decision in Step S10 is “Yes”, the ECU 21 judges that the output of the intake air flow sensor 6 is excessively high, and turns on the warning light 30, in Step S12, thereby notifying the driver of the need for repair.

If the operating state of the engine 1 is judged to be in the high flow rate region and thus the decision in Step S8 is “Yes”, the ECU 21 advances the procedure to Step S14 and makes the low-output failure judgment on the output of the intake air flow sensor 6, namely, it is determined whether or not the ratio R assumes a value greater than or equal to a low-output failure criterion value Runder (low-output failure judgment means). The low-output failure criterion value Runder corresponds to an allowable limit on decremental error of the detected intake air flow rate Qa relative to the theoretical intake air flow rate Qao. Naturally, therefore, the low-output failure criterion value Runder is set to a value (e.g., “3.0”) greater than “1.0” (i.e., Qao=Qa). If the decision in Step S14 is “No”, the ECU 21 judges that the output of the intake air flow sensor 6 is not excessively low, and terminates the routine. On the other hand, if the decision in Step S14 is “Yes”, the ECU 21 judges that the output of the intake air flow sensor 6 is excessively low, and advances the procedure to the aforementioned Step S12.

Following the procedure described above, the ECU 21 executes the failure diagnosis routine. Specifically, if the ECU 21 judges in Step S6 that the operating state of the engine 1 falls within the low flow rate region, the high-output failure judgment is made in Step S10. On the other hand, if the ECU 21 judges in Step S8 that the operating state of the engine 1 falls within the high flow rate region, the low-output failure judgment is made in Step S14.

In the low flow rate region in which the intake air flow rate is originally low, decrease in the detected intake air flow rate Qa does not show itself clearly, but increase in the detected intake air flow rate Qa appears noticeably. On the other hand, in the high flow rate region in which the intake air flow rate is naturally high, increase in the detected intake air flow rate Qa does not show itself clearly, but decrease in the detected intake air flow rate Qa appears noticeably. As stated above, the high-output failure judgment is made in the low flow rate region by the ECU 21 to determine whether the intake air flow sensor 6 has failed or not, with the use of the ratio R as indicative of an increase in the detected intake air flow rate Qa relative to the theoretical intake air flow rate Qao. Accordingly, if the detected intake air flow rate Qa increases because of error attributable to sensor failure, the increase of the detected flow rate is distinctly reflected in the ratio R as a decrease of its value, so that the ECU 21 judges that the intake air flow sensor 6 has failed. Similarly, the low-output failure judgment is made in the high flow rate region by the ECU 21 in order to determine whether the intake air flow sensor 6 has failed or not, with the use of the ratio R as indicative of a decrease in the detected intake air flow rate Qa relative to the theoretical intake air flow rate Qao. Accordingly, if the detected intake air flow rate Qa decreases because of error attributable to sensor failure, the decrease of the detected flow rate is distinctly reflected in the ratio R as an increase of its value, so that the ECU 21 judges that the intake air flow sensor 6 has failed.

In this manner, the ECU 21 makes the high- and low-output failure judgments in their respective limited operating regions where increase and decrease of the detected intake air flow rate Qa due to error of the intake air flow sensor 6 appear distinctly, whereby failure of the sensor 6 can be determined properly at all times. As a result, erroneous judgment of failure can be prevented, ensuring high-accuracy judgment as to failure of the intake air flow sensor 6. Accordingly, it is possible to avoid an undesirable situation where, for example, although the intake air flow sensor 6 has actually failed, the sensor failure is not detected and the EGR control is performed on the basis of an inaccurate intake air flow rate Qa, which results in deterioration in the emission characteristics of the engine 1.

When the high flow rate region is discriminated in Step S8, an additional requirement, namely, the opening of the EGR valve 15 is checked, besides the requirements used for discriminating the low flow rate region in Step S6, as mentioned above. Specifically, if the opening of the EGR valve 15 is found to be greater than or equal to a predetermined value in Step S8, for example, and thus it is judged by the ECU 21 that the quantity of EGR gas recirculated to the intake side is greater than or equal to a predetermined quantity, the ECU 21 concludes that the operating state of the engine 1 is not in the high flow rate region (the decision in Step S8 is “No”), even if the other requirements are satisfied.

In the high flow rate region where the intake air flow rate is high, the exhaust pressure of the engine 1 is high, and as the exhaust pressure increases, the EGR gas recirculated to the intake side exerts a greater influence on the intake air flow rate. The influence of the EGR having such tendency possibly lowers the accuracy of the low-output failure judgment based on the ratio R, depending on the EGR quantity. According to the embodiment, however, when the EGR quantity is large, the ECU 21 judges that the engine operating state is not in the high flow rate region, and thus does not make the low-output failure judgment of Step S14, which is applied to the high flow rate region, as stated above. It is therefore possible to prevent a situation where the low-output failure judgment is made erroneously due to the influence of the EGR quantity.

While the preferred embodiment has been described above, it is to be noted that the present invention is not limited to the foregoing embodiment alone. For example, in the above description, the present invention is embodied as an apparatus for failure diagnosis of the intake air flow sensor 6 of the diesel engine 1 equipped with the turbocharger 7, but the type of the engine 1 is not limited to such engine alone. The present invention may be applied, for example, to a naturally aspirated diesel engine without the turbocharger 7 or to a gasoline engine.

Also, in the above embodiment, the ECU 21 makes the high- and low-output failure judgments by comparing the ratio R (=Qao/Qa) of the theoretical intake air flow rate Qao to the detected intake air flow rate Qa respectively with the high- and low-output failure criterion values Rover and Runder, but the manner of making these judgments is not particularly limited. For example, the ECU 21 may obtain a difference between the theoretical intake air flow rate Qao and the detected intake air flow rate Qa, and compare the difference with respective criterion values to make the high- and low-output failure judgments.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for failure diagnosis of an intake air flow sensor, comprising:
intake air flow rate region discrimination means for determining whether or not an operating state of an engine falls within either one of a preset low flow rate region where an intake air flow rate of the engine is low, and a preset high flow rate region where the intake air flow rate is high;
theoretical intake air flow rate calculation means for calculating, based on the operating state of the engine, a theoretical intake air flow rate corresponding to an actual intake air flow rate;
an intake air flow sensor for detecting the intake air flow rate of the engine;
high-output failure judgment means for determining, when it is judged by the intake air flow rate region discrimination means that the operating state of the engine is in the low flow rate region, whether or not the intake air flow rate detected by the intake air flow sensor is excessively high relative to the theoretical intake air flow rate calculated by the theoretical intake air flow rate calculation means, and judging, if the detected intake air flow rate is found to be excessively high, that the intake air flow sensor has failed; and
low-output failure judgment means for determining, when it is judged by the intake air flow rate region discrimination means that the operating state of the engine is in the high flow rate region, whether or not the intake air flow rate detected by the intake air flow sensor is excessively low relative to the theoretical intake air flow rate calculated by the theoretical intake air flow rate calculation means, and judging, if the detected intake air flow rate is found to be excessively low, that the intake air flow sensor has failed.

2. The apparatus for failure diagnosis of an intake air flow sensor according to claim 1, wherein the intake air flow rate region discrimination means determines, based at least on status of exhaust gas recirculation to an intake side of the engine, whether or not the operating state of the engine falls within the high flow rate region.

3. The apparatus for failure diagnosis of an intake air flow sensor according to claim 2, wherein, if a quantity of exhaust gas recirculated to the intake side of the engine is found to be greater than a predetermined quantity, the intake air flow rate region discrimination means judges that the operating state of the engine is not in the high flow rate region.

4. The apparatus for failure diagnosis of an intake air flow sensor according to claim 3, wherein, when an opening of an EGR valve for adjusting the quantity of the exhaust gas recirculated to the intake side of the engine is greater than a predetermined opening, the intake air flow rate region discrimination means judges that the quantity of the recirculated exhaust gas is greater than the predetermined quantity.

5. The apparatus for failure diagnosis of an intake air flow sensor according to claim 1, wherein the theoretical intake air flow rate calculation means calculates the theoretical intake air flow rate by obtaining a base intake air flow rate based on a revolving speed of the engine, and correcting the base intake air flow rate with use of an atmospheric pressure, an intake air temperature of the engine, a cooling water temperature of the engine, an intake air pressure of the engine, and a fuel supply quantity of the engine.

6. The apparatus for failure diagnosis of an intake air flow sensor according to claim 1, wherein the intake air flow rate region discrimination means sets, as the low flow rate region, a first predetermined region where a revolving speed of the engine is relatively low and a fuel supply quantity of the engine is relatively small, and sets, as the high flow rate region, a second predetermined region where the revolving speed of the engine is higher than those falling within the low flow rate region and the fuel supply quantity of the engine is greater than those falling within the low flow rate region.

7. The apparatus for failure diagnosis of an intake air flow sensor according to claim 1, wherein the intake air flow rate region discrimination means sets, as the low flow rate region, a region where the intake air flow rate is relatively low within an entire intake air flow rate region of the engine, and sets, as the high flow rate region, a remaining region of the entire intake air flow rate region other than the low flow rate region.
